(19) United States
(12) Patent Application Publication
(10) Pub. No.: US 2014/0280481 A1
(43) Pub. Date: Sep. 18, 2014

(54) Hierarchical Application Client System

(71) Applicant: BEEONICS, INC., Waltham, MA (US)

(72) Inventors: Fabio M. Chiussi, Long Branch, NJ (US); Parameshwar Hegde, Westford, MA (US)

(73) Assignee: Beeonics, Inc., Waltham, MA (US)

(21) Appl. No.: 13/834,765

(22) Filed: Mar. 15, 2013

(51) Int. Cl. H04L 29/08

(52) U.S. Cl. CPC H04L 67/10
USPC 709/203

(57) ABSTRACT

A System Solution offers a Business Entity the generation of a plurality of User Experiences offered by a Two-Layer Native Application Client, stores these experiences in the client device or in an Application Server, and provides a way to directly download dynamically User Experiences while the Two-Layer Native Application Client is running on the Client Device. The Two-Layer Native Application Client automatically downloads a first User Experience based on a first condition and a second User Experience in the plurality of User Experiences based on a second condition. A plurality of Applications shares a common Native Layer and is downloaded dynamically to the Client Device. A first and a second Application in the plurality of Applications runs simultaneously on the client device. The System Solution generates Dashboards that can be used to modify dynamically the Dynamic Layers and Applications in the pluralities of Two-Layer Native Application Clients.

### CROSS-REFERENCE TO RELATED APPLICATIONS

The present application is related to the co-filed U.S. application Ser. No. 13/______ entitled “Apparatus for Single Workflow for Multi-Platform Mobile Application Creation and Delivery”, Ser. No. 13/______ entitled “Method for Single Workflow for Multi-Platform Mobile Application Creation and Delivery”, Ser. No. 13/______ entitled “Dynamic User Interface Delivery System”, and Ser. No. 13/______ entitled “User Interface and Content Translation System”, filed on Mar. 15, 2013, which are assigned to the same assignee as the present application and invented by the same inventors as the present application and incorporated herein by reference in its entirety.

### BACKGROUND OF THE INVENTION

The internet is a communication system that interconnects the world. The internet has been structured to provide connectivity to billions of users with laptops, notebooks, desktops, Internet Enabled TV sets, cellular phones, smartphones like the iPhone™, Android™ and Blackberry™, wearable devices, and tablets. The internet 1-3 connects a Client Device 1-2 to a server 1-4 and the server to the same Client Device as illustrated in 1-1 of FIG. 1A or to another Client Device (not illustrated). The Client Device 1-2 can have at least one display screen 1-8 that can be a touch sensitive screen, pen based or both. The screen can display various icons or be attached to a physical or displayed keypad 1-9. As illustrated in 1-1, the Client Devices are physical and can be either mobile, such as cellular phones, smartphones, wearable devices, and tablets, or non-mobile, such as laptops, desktops, and Internet-Enabled TV sets. The Client Devices 1-2 are coupled to the internet by wired (a physical interconnect), wirelessly (waves through space), or both wired/wireless networks. The wireless connectivity can be cellular (3G, 4G, etc.), Wi-Fi, Bluetooth, WiMax, etc. The Client Device 1-2 runs the Application Client which is the actual application software running on device.

FIG. 1A also shows an Application Store 1-10 connected to the Internet. The Application Store makes application clients available for download to the Client Devices. There is a plurality of Application Stores, each of the Application Stores dedicated to make available for download Application Clients for a certain type of Client Device or Client Device Operating System. For example, the Apple™ Application Store makes Application Clients for the iPhone™ and iPad™ available for download, the Android™ Application Store makes Application Clients for smartphones and tablets running the Android™ Operating System available for download, etc. There are Application Stores dedicated to support mobile Client Devices (for example, the iPhone™/iPad™ Apple™ Application Store, the Blackberry™ Application Store, etc.), and Application Stores dedicated to support non-mobile Client Devices (for example, the Mac™ Apple™ Application Store, which makes applications for Apple™ computers running the Mac™ Operating System available for download).

The Cloud uses the network of the internet to offer services to users by using a combination of hardware and software embedded in the network. An Application Client can be in the Cloud, but in this case the Client Device is a “virtual” Client Device. The “virtual” Client Device has a way to provide access to the Application Client running in the cloud via a physical Client Device. For example, as in the example listed in 1-5 of FIG. 13, a web browser 1-6 running on the physical Client Device 1-2 and coupled to the client/server 1-7 in the Cloud via the Internet accesses the Application Client running in the Cloud, which performs the actual application software. For the Cloud, there are two cases: the entire Application Client runs in the Cloud, or a small portion of the Application Client runs on a physical Client Device while most of the logic runs in the Cloud.

FIG. 2A illustrates a system 2-1 with the hardware 2-16 and software 2-15 of a Client Device 1-2. The Client Device 1-2 is coupled to the internet 1-3 via wireline connection or Radio Frequency (RF) wireless transmission network (wired/wireless) 2-2 and further coupled to a bank of servers 2-4 via a second interconnection 2-3 that can be wired or wireless. The communication link is a receiver and a transmitter known as a transceiver and is coupled to either a wired connector or an antenna (not illustrated) for the wireline connection or RF wireless transmission network, respectively. In general, these links: wired, wireless, cellular, internet, etc. are called the Communication network. The Communication network couples all components together. The server's bank 2-4 comprises server-0 2-11 to server-N 2-12. The bank contains at least one server and these servers can be localized, coupled by an Intranet, or be physically separated from one another, coupled by the Internet. The Operating System (OS) 2-13 running in the Client Device is closely coupled with the hardware 2-16, especially in case of Mobile Client Devices 1-2. The hardware 2-16 comprises at least one processor 2-5 operating under the Operating System 2-13. The processor 2-5 is coupled to at least one memory 2-7 and at least one communication link 2-9 via at least one bus 2-8. The communication link 2-9 couples the Client Device to the outside world through a wired and/or wireless interconnection via the transceiver. The Client Device offers the user at least one mode of input and one mode of output. One mode of input to the Client Device 1-2 is via the touch based keypad 2-6 or through voice control (not illustrated). The screen 2-10 can be a touch sensitive screen and provide a second mode of input. The screen 2-10 can provide an output response or sound can provide a second mode of output known as voice output (not illustrated). Other hardware components such as MEMS, power supplies, etc. are not mentioned but are well-known by those skilled in the art. A set of applications or Application Clients 2-14 run on the Client Device are coupled to the Operating System 2-13. The Client Device is one of a plurality of Client Devices coupled to the Internet. The Application Store 1-10 is coupled to the Internet via communication link 2-21.

FIG. 2B illustrates that when the term server 2-20 is used, this server is a sub-set representation of a Computer hardware 2-17, which can contain software 2-18, a database 2-19 and the server 2-20 itself. Other components not illustrated are the memory, power supply, etc. One skilled in the art would be knowledgeable of the other components contained in this device and will not be described further. All servers used in this specification are substantially the same as the server 2-20. Furthermore, a plurality of servers and a plurality of databases can be embedded in the Computer hardware 2-17.

The term “Client Device” encompasses the device being mobile, non-mobile, or located in the Cloud. However, in some cases, for further distinction within this document the term “Mobile Client Device” will be used for mobile devices, “Non-Mobile Client Device” will be used for non-mobile devices and “Cloud Client Device” will be used for the device formed in the Cloud.

FIG. 3A and FIG. 3B present two different types of Application Clients 1-2 and 1-2a. This distinction is especially relevant in the case of mobile Client Devices, but is also applicable to non-mobile Client Devices. FIG. 3A shows a Native Application Client and how it relates to the layered stacks of the hardware/software representation of a Client Device. The Native Application Client 3-1 is an executable which runs directly on the Operating System 2-13 of the Client Device 1-2, which in turn runs on the hardware 2-16 of the Client Device. The Operating System 2-13 provides a set of system libraries 3-5, which the Native Application Client uses 3-2. The Native Application Client is compiled to run on the Operating System of the Client Device. The Native Application Client needs to be downloaded to the Client Device and installed on the Client Device in order to run on the Client Device.

FIG. 3B shows a Non-Native Application Client and how it relates to the layered stacks of the hardware/software representation of a Client Device. The Non-Native Application Client 3-1b does not run directly on the Operating System 2-13h of the Client Device, but instead uses a web browser 3-3 installed on the Client Device in order to run. The Non-Native Application Client 3-1h is written in a programming language that is understood by the web browser running on the Client Device. The most common example of such a language is HTML5. The web browser running on the Client Device contains a parser 3-4 that is used to interpret the code of the Non-Native Application Client 3-1h. The Non-Native Application Client 3-1h does not depend on the Client Device 1-2a since it does not run directly on the Operating System 2-13h but instead uses the web browser 3-3 running on the Client Device 1-2a. The Non-Native Application Client 3-1h can run on any Client Device 1-2a that runs a web browser 3-3 capable of understanding the language which the Non-Native Application Client is written in. The web browser 3-3 may depend on the Client Device 1-2a, but the Non-Native Application client does not depend on the Client Device. The Operating System 2-13h runs on the hardware 2-16h.

The term “Application Client” refers to the portion of the application running on the Client Device. The term “Application Client” encompasses the Application Client running on a mobile Client Device, a non-mobile Client Device or even in the Cloud. The Cloud can run a portion of the Application Client in the server while the remaining portion of the Application Client can run on the Client Device, simultaneously. The term “Application Client” is used to refer to both Native and Non-Native Application Client. The term “Mobile Application Client” will be used for both Native and Non-Native Application Clients running on a mobile Client Device, but it also applies to Client Devices that are non-mobile or in the Cloud.

An approval and download process in the Application Store is illustrated in FIG. 4A. A Business Entity 4-1 creates a new application which comprises a new Native Application Client 3-1. The new Native Application Client 3-1 is submitted 4-3 to the Application Store 1-10 for an approval process 4-4. Once the new Native Application Client is accepted 4-5, information is passed to the Application Store 1-10 to make the new Native Application Client available for download into a Client Device 1-2. A Client Device 1-2 which desires the Native Application Client 3-1 downloads 4-6 the Native Application Client from the corresponding Application Store 1-10. For example, an iPhone™ downloads its desired Native Application Client from the Apple™ Application Store, an Android™ device downloads its desired Native Application Client from the Android™ Application Store, etc. Once the Native Application Client is downloaded to the Client Device, it is installed on the Client Device so it can run on the Operating System of the Client Device. The client now contains a “native” application coupled to the Operating System 2-13 (see FIG. 2A) of the Client Device. The Native Mobile Application Client executable depends on the Operating System (OS) as an iPhone would require a different executable than an Android™ phone.

FIG. 4B illustrates if the Business Entity 4-1 makes a change to the Native Application Client 3-1, the Updated Native Application Client 4-7 must be re-submitted 4-8 to the Application Store approval process 4-4 and re-accepted 4-9 in order for the updated Native Application Client to be made available in the Application Store 1-10 for download. A Client Device which desires the updated Native Application Client 4-7 must download it 4-10 again from the Application Store 1-10 and re-install the Native Application Client on the Client Device 1-2. The process of updating an existing Native Application Client takes considerable time and effort. The Business Entity 4-1 must re-submit the Native Application Client to the Application Store, which requires considerable time and effort since the submission procedure is typically laborious and time-consuming. The Application Store must expend funds to re-approve the new executable and the approval process may take considerable time. Once accepted, the store must distribute the new Native Application Client to the Client Device. A Client Device 1-2 which desires the updated Native Application Client must go back to the Application Store 1-10 and download the updated version of the Native Application Client and re-install it on the Client Device 1-2. The existing Native Application Client 3-1, if running on the Client Device 1-2, must be stopped and deleted from the memory of the Client Device 1-2 in order for the updated Native Application Client 4-7 to be installed on the Client Device 1-2. An existing Native Application Client 3-1 cannot be updated while it is running on the Client Device 1-2. An existing Native Application Client 3-1 cannot manage the update process, but must rely on an external installation manager software or update manager software running on the Operating System of the Client Device to delete the existing Native Application Client, download and re-install the updated Native Application Client 4-7, and complete the update process.

### BRIEF SUMMARY OF THE INVENTION

It is a first objective of the invention to provide a System Solution to automatically generate a Native Application Client that offers the Business Entity a way to generate a plurality of User Experiences, the User Experiences directly downloaded to the Native Application Client from an Application Server that is part of the System Solution or is owned by the Business Entity, and offer the User Experiences to the end user interchangeably by the Native Application Client.

It is a second objective of the invention to provide a System Solution to store the plurality of User Experiences in the Client Device or to store the plurality of User Experiences in an application server that is part of the System Solution or is owned by the Business Entity and provide a way to download such User Experiences dynamically and in an optimized fashion while the Native Application Client is running on the Client Device and when the User Experiences are needed to be displayed by the Native Application Client.

It is a third objective of the invention to provide a System Solution to download a first User Experience in the plurality of User Experiences based on a first condition that is automatically evaluated by the Native Application Client and download a second User Experience in the plurality of User Experiences based on a second condition that is automatically evaluated by the Native Application Client.

It is a fourth objective of the invention to provide a System Solution to offer a plurality of Business Entities a way to automatically generate a plurality of Native Application Clients that share a single executable that needs to be downloaded from an Application Store in order for the plurality of Native Application Clients to be able to run on a Client Device. Once the single executable is downloaded and installed on the Client Device, the functionality of the plurality of Native Application Clients is downloaded to the Client Device from an Application Server that is part of the System Solution or is owned by the Business Entity while a first Native Application Client in the Plurality of Native Application Clients is running on the Client Device.

It is a fifth objective of the invention to provide a System Solution to store the functionality of the plurality of Native Application Clients in the Client Device or to store functionality of the plurality of Native Application Clients in an application server that is part of the System Solution or is owned by the Business Entity and provide a way to download a first functionality of the plurality of Native Application Clients dynamically and in an optimized fashion while the common executable is running on the Client Device.

It is a sixth objective of the invention to provide a System Solution to download a first functionality in the plurality of Native Application Clients based on a first condition that is automatically evaluated by the Native Application Client and download a second functionality of the plurality of Native Application Clients based on a second condition that is automatically evaluated by the Native Application Client.

It is a seventh objective of the invention to provide a System Solution to offer a plurality of Business Entities a way to automatically generate a plurality of Native Application Clients that share a single executable that needs to be downloaded from an Application Store in order for the plurality of Native Application Clients to be able to run on a Client Device, and run the functionality of a first and second Native Application Client in the plurality of Native Application Clients at the same time on the Client Device.

A preferred embodiment of the invention is a method to generate a Native Application Client which consists of a common Native Layer which runs directly on the Operating System of the Client Device and is downloaded from the Application Store, and a plurality of Dynamic Layers, which run on the common Native Layer and can be downloaded from the Application Store, but can also be downloaded directly from an application server which is part of the System Solution or owned by the Business Entity while the Native Application Client is running on the Client Device. The functionality provided by the common Native Layer together with a first Dynamic Layer in the plurality of Dynamic Layers provides a first User Experience that the Native Application Client offers to the user on the Client Device.

In this preferred embodiment of the invention, the entire plurality of Dynamic Layers can be downloaded from an application server that is part of the system solution or is owned by the Business Entity and stored in the Client Device. The entire plurality of User Experiences corresponding to the plurality of Dynamic Layer is stored in the Client Device, and a first User Experience in the plurality of User Experiences is substituted by a second User Experience in the plurality of User Experiences while the Native Application Client is running on the Client Device.

In another preferred embodiment of the invention, the plurality of Dynamic Layers is stored in an application server that is part of the system solution or is owned by the Business Entity and is downloaded to the Client Device only when it is needed to be displayed to the end user on the Client Device.

In another preferred embodiment of the invention, the plurality of Dynamic Layers is stored in an application server that is part of the system solution or is owned by the Business Entity and only the portion of the Dynamic Layer that needs to be displayed to the end user is downloaded to the Client Device, at the time when it is needed to be displayed to the end user. The Native Application Client and the application server optimize the bandwidth utilization of the communication link between the Client Device and server and optimize the storage of the Native Application Client data on the Client Device.

In another preferred embodiment of the invention, a first Dynamic Layer in the plurality of Dynamic Layers is selected to be displayed to the end user while the common Native Layer is running on the Client Device based on a first condition that is evaluated by the common Native Layer while it is running on the Client Device, and a second Dynamic Layer in the plurality of Dynamic Layers is selected to be displayed to the end user while the common Native Layer is running on the Client Device based on a second condition that is evaluated by the common Native Layer while it is running on the Client Device.

Another preferred embodiment of the preferred invention includes the apparatus comprising Computing devices with dedicated servers running the System Solution that, based on the a Service Representation selected by the Business Entity and a Business Entity Data, runs an Automatic Data Model Generator. This Automatic Data Model Generator places the widely varying and random data positioning from any Business Entity into a well-defined Data Model which acts as an interface between the Automatic Data Model Generator and an Automatic Application Generator. The Automatic Application Generator uses the data from the Data Model to automatically generate an Application comprising a plurality of Application Components, including an Application Server, a set of Two-Layer Native Mobile Application Clients supporting a plurality of Dynamic Layers that run on a common Native Layer, a set of Two-Layer Non-Native Non-Mobile Application Clients supporting a plurality of Dynamic Layers that run on a common Native Layer, Non Native Mobile Application Clients, Client server protocol, dashboards and other components. The plurality of Dynamic Layers implements a plurality of User Experiences running on the Native and Non-Native Application Clients. The plurality of Dynamic Layers of the Native Mobile and Non-Mobile Application Clients in the set of generated Two-Layer Native Mobile and Non-Mobile Application Clients can be downloaded to the Client Devices using the generated Application Server and the generated Client server protocol. The generated Dashboards can be used by the Business Entity to modify the Dynamic Layers in the pluralities of Dynamic Layers in the Two-Layer Native Mobile Application Clients and the Two-Layer Native Non-Mobile Application Clients, and to modify the Non-Native Application Clients. The generated Dashboards can be used by the Business Entity to add new Dynamic Layers to the pluralities of Dynamic Layers in the Two-Layer Native Mobile Application Clients and the Two-Layer Native Non-Mobile Application Clients, and to modify the Non-Native Application Clients.

Another preferred embodiment of the invention is a method offered to a plurality of Business Entities to generate a plurality of Native Application Clients which share a common Native Layer which runs directly on the Operating System of the Client Device and is downloaded from the Application Store, and a plurality of Dynamic Layers, which run on the shared common Native Layer. The functionality provided by the shared common Native Layer together with a first Dynamic Layer in the plurality of Dynamic Layers provides the functionality of a first Native Application Client. The functionality provided by the shared common Native Layer together with a second Dynamic Layer in the plurality of Dynamic Layers provides the functionality of a second Native Application Client. Once the shared common Native Application Client is downloaded from the Application Store and is installed on the Client Device, the functionality of the plurality of Native Application Clients can be downloaded directly from an application server which is part of the System Solution or owned by the Business Entity while a first Native Application Client in the plurality of Native Application Clients is running on the Client Device.

In this preferred embodiment of the invention, the functionality of the entire plurality of Native Application Clients can be downloaded from an application server that is part of the system solution or is owned by the Business Entity and stored in the Client Device. The entire plurality of Native Application Clients is stored in the Client Device, and a first Native Application Client in the plurality of User Experiences is substituted by a second Native Application Client in the plurality of Native Application Client while the first Native Application Client is running on the Client Device.

In another preferred embodiment of the invention, the functionality of the plurality of Native Application Clients is stored in an application server that is part of the system solution or is owned by the Business Entity and is downloaded to the Client Device only when it is needed to be displayed to the end user on the Client Device.

In another preferred embodiment of the invention, the functionality of the plurality of Native Application Clients is stored in an application server that is part of the system solution or is owned by the Business Entity and only the portion of the functionality of the Native Application Clients that needs to be displayed to the end user is downloaded to the Client Device, at the time when it is needed to be displayed to the end user. The Native Application Client and the application server optimize the bandwidth utilization of the communication link between the Client Device and server and optimize the storage of the Native Application Client data on the Client Device.

In another preferred embodiment of the invention, a first Native Application Client in the plurality of Native Application Clients is selected to be run on the Client Device while the shared common Native Layer is running on the Client Device based on a first condition that is evaluated by the common Native Layer while it is running on the Client Device, and a second Native Application Client in the plurality of Native Application Clients is selected to be displayed to the end user while the common Native Layer is running on the Client Device based on a second condition that is evaluated by the common Native Layer while it is running on the Client Device.

Another preferred embodiment of the invention includes the apparatus comprising Computing devices with dedicated servers running the System Solution that, based on a plurality of Service Representation selected by a plurality of Business Entity and a plurality of Business Entities Data, runs an Automatic Data Model Generator. This Automatic Data Model Generator places the widely varying and random data positioning from the plurality of Business Entities into a well-defined Data Model which acts as an interface between the Automatic Data Model Generator and an Automatic Application Generator. The Automatic Application Generator uses the data from the plurality of Data Model to automatically generate a plurality of Applications comprising a plurality of Application Components, each Application in the plurality of Applications including an Application Server, a set of Two-Layer Native Mobile Application Clients, a set of Two-Layer Non-Native Non-Mobile Application Clients, Non Native Mobile Application Clients, Client server protocol, dashboards and other components. The Native Application Clients in the sets of generated Native Mobile and Non-Mobile Application Clients for different Applications in the plurality of generated Application share a common Native Layer. The plurality of Dynamic Layers implements a plurality of Native Application Clients running on the shared common Native Layer. For each Application in the plurality of Applications, the Dynamic Layer of the Native Mobile and Non-Mobile Application Clients in the set of generated Two-Layer Native Mobile and Non-Mobile Application Clients can be downloaded to the Client Devices using the generated Application Server and the generated Client server protocol. The generated Dashboards can be used by the Business Entities to modify the Dynamic Layers in the pluralities of Native Application Clients in the Two-Layer Native Mobile Application Clients and the Two-Layer Native Non-Mobile Application Clients, and to modify the Non-Native Application Clients. The generated Dashboards can be used by the Business Entities to add new functionality to the pluralities of Native Application Clients in the Two-Layer Native Mobile Application Clients and the Two-Layer Native Non-Mobile Application Clients, and to modify the Non-Native Application Clients.

Another preferred embodiment of the invention includes a method to offered to a plurality of Business Entities to generate a plurality of Native Application Clients which share a common Native Layer which runs directly on the Operating System of the Client Device and is downloaded from the Application Store, and a plurality of Dynamic Layers, which can run on the shared common Native Layer at the same time. Once the shared common Native Application Client is downloaded from the Application Store and is installed on the Client Device, the functionality of the plurality of Native Application Clients can be downloaded directly from an application server which is part of the System Solution or owned by the Business Entity while a first Native Application Client in the plurality of Native Application Clients is running on the Client Device and a plurality of Native Application Clients can be run on the Client Device at the same time.

Another preferred embodiment of the invention is a method offered to a plurality of Business Entities to generate a plurality of Native Application Clients which share a common Native Layer which runs directly on the Operating System of the Client Device and is downloaded from the Application Store, and a plurality of Dynamic Layers. A second Dynamic Layer in the plurality of Dynamic Layers runs on a first Dynamic Layer in the plurality of Dynamic Layers, which in turn runs on the common Native Layer. The functionality provided by the shared common Native Layer together with the first Dynamic Layer in the plurality of Dynamic Layers provides the functionality of a first Native Application Client. The functionality provided by the shared common Native Layer together with the first and second Dynamic Layer in the plurality of Dynamic Layers provides the functionality of a second Native Application Client.

In this preferred embodiment of the invention the Dynamic Layers in the plurality of Dynamic Layers can be stored in the Client Device or can be downloaded to the Client Devices only when they are needed to be displayed to the end user, or only the portions of the Dynamic Layers in the plurality of Dynamic Layers that needs to be displayed to the end user is downloaded to the Client Device. The download of the Dynamic Layers may depend on a condition evaluated automatically in the common Native Layer.

In accordance with another preferred embodiment of the invention, a System Apparatus comprising a Client Device with a Two-Layer Native Application Client, a first Operating System, a first hardware, and a first screen, the Two-Layer Native Application Client with a Native Layer and a first Dynamic Layer, and a plurality of first Dynamic Layers stored on the Client Device to offer a Business Entity a way to generate a plurality of User Experiences for the Client Device. The System Apparatus further comprising a plurality of conditions associated with each of the plurality of first Dynamic Layers, and the plurality of conditions are also events based on Client Device location, date, time, network connectivity, and Client Device state. The System Apparatus wherein the Two-layer Native Application Client was downloaded from an Application store. The System Apparatus further comprising a System Solution to automatically generate the Two-Layer Native Application Client that offers a Business Entity a way to generate the plurality of User Experiences. The System Apparatus further comprising a new User Experience from the plurality of User Experiences stored on the Client Device is automatically generated by the Two-Layer Native Application Client based on a new condition from a plurality of conditions. The System Apparatus further comprising a Download manager located in the Native Layer of the Client Device, a plurality of second Dynamic Layers stored on an Application Server to offer the Business Entity a way to generate a second plurality of User Experiences for the Client device, the Two-Layer Native Application Client automatically downloads at least one new Dynamic Layer from the Application Server to generate at least one new User Experience from the second plurality of User Experiences for the Client Device. The System Apparatus further comprising a Download manager located in the Native Layer of the Client Device, a plurality of second Dynamic Layers stored on an Application Server to offer the Business Entity a way to generate a second plurality of User Experiences for the Client device, the Two-Layer Native Application Client automatically evaluates at least one new condition from a plurality of conditions and based on the evaluated condition downloads at least one new Dynamic Layer from the Application Server to generate at least one new User Experience from the second plurality of User Experiences for the Client Device. The System Apparatus further comprising updated components of Page Surfaces of the at least one new Dynamic Layer are only downloaded to optimize a bandwidth utilization of a communication link between the Client Device and the Application Server.

In accordance with another preferred embodiment of the invention, a method of downloading multiple Dynamic Layers comprising the steps of generating a plurality of Application Clients automatically using a System Solution with at least one first server and with at least one Computing device, coupling the plurality of Application Clients to a Client Device where each Application Client in the plurality of Application Clients is a Two-layer native Application Client comprising a Native Layer and a Dynamic Layer, allowing the Native Layer to be a Common Native Layer, and downloading automatically from an Application Server multiple Dynamic Layers corresponding to different Application Clients in the plurality of Application Clients to the Client Device. The method wherein the coupling of the entire plurality of Application Clients is through the coupling of a single Application Client through an Application Store. The method further comprising the steps of allowing a User of the Client Device to select a desired Application and downloading the one desired Dynamic layer of the multiple Dynamic Layers to the Client Device. The method further comprising the steps of using a Download Manager in the Common Native Layer to select the multiple Dynamic layers in the Application Server. The method further comprising the steps of selecting a desired Application based on a plurality of condition at the Client Device, and using a Download Manager in the Common Native Layer to select and download one of the multiple Dynamic layers in the Application Server, and in addition, the method wherein the plurality of conditions are also events based on Client Device location, date, time, network connectivity, and Client Device state. The method further comprising the steps of downloading only updated components of Page Surfaces of the multiple Dynamic Layers and optimizing a bandwidth utilization of a communication link between the Client Device and the Application Server.

In accordance with another preferred embodiment of the invention, a method of running multiple Dynamic Layers at the same time comprising the steps of generating a plurality of Application Clients automatically using a System Solution with at least one first server and with at least one Computing device, coupling the plurality of Application Clients to a Client Device where each Application Client in the plurality of Application Clients is a Two-layer native Application Client comprising a Native Layer and a plurality of Dynamic Layers, allowing the Native Layer to be a Common Native Layer, downloading automatically from an Application Server at least two or more of a plurality of Dynamic Layers corresponding to different Applications to the Client Device, and running the downloaded the at least two or more of the plurality of Dynamic Layers in a series configuration or a parallel configuration simultaneously. The method comprising the steps of running a first of the at least two or more of the plurality of Dynamic Layers on a second of the at least two or more of the plurality of Dynamic Layers, running the second of the at least two or more of the plurality of Dynamic Layers simultaneously on the Common Native Layer, and forming the series configuration. The method comprising the steps of running a first of the at least two or more of the plurality of Dynamic Layers on the Common Native Layer, running at least one of remaining the at least two or more of the plurality of Dynamic Layers simultaneously on the Common Native Layer, and forming the parallel configuration, and the method further comprising the steps of achieving multi-tasking between different Applications and allowing a Client Device which does not support the multi-tasking to support the multi-tasking. The method wherein a first portion of the plurality of Dynamic Layers can be stored in the Client Device and the remaining portion of the plurality of Dynamic Layers can be stored in an Application Server.

### BRIEF DESCRIPTION OF THE DRAWINGS

Please note that the drawings shown in this specification may not necessarily be drawn to scale and the relative dimensions of various elements in the diagrams are depicted schematically. The inventions presented here can be embodied in many different forms and should not be construed as limited to the embodiments set forth herein. Rather, these embodiments are provided so that this disclosure will be thorough and complete, and will fully convey the scope of the invention to those skilled in the art. In other instances, well-known structures and functions have not been shown or described in detail to avoid unnecessarily obscuring the description of the embodiment of the invention. Like numbers refer to like elements in the diagrams.

FIG. 1A depicts a Client Device coupled to a server and an Application Store and provides some examples of Client Devices.

FIG. 1B depicts a Client Device coupled to a client/server.

FIG. 2A shows a Client Device with a coupling to a bank of servers, an Application Store, and the internal hardware/software structure of the Client Device.

FIG. 2B depicts a more detailed description of a server being a subset of Computer hardware with software, a Database and the server.

FIG. 3A presents a Native Application Client and how it relates to the layered stacks of the hardware/software representation of a Client Device.

FIG. 3B illustrates a Non-Native Application Client and how it relates to the layered stacks of the hardware/software representation of a Client Device.

FIG. 4A shows the flow of how a Native Application Client is approved and downloaded by an Application Store to a Client Device.

FIG. 4B illustrates the flow of how a new Updated Native Application Client is approved and downloaded by an Application Store to a Client Device.

FIG. 5 depicts a Two-Layer Application Client in a Client Device in accordance with the present invention.

FIG. 6A shows a first time download for a Two-Layer Native Application Client in accordance with the present invention.

FIG. 6B presents a Business Entity submitting a Two-Layer Application Client for approval and download to an Application Store for availability to other Device Clients in accordance with the present invention.

FIG. 7A shows the automatic generation of a Two-Layer Application Client in accordance with the present invention.

FIG. 7B illustrates how the Dashboards are used to modify the Dynamic layers in accordance with the present invention.

FIG. 8A depicts an Application Client consisting of Pages in accordance with the present invention.

FIG. 8B illustrates Page Surface and Page Foundation in accordance with the present invention.

FIG. 9A shows an Update Manager continuously checking if there is an update on the Application Server in accordance with the present invention.

FIG. 9B illustrates only the Surface(s) that are updated are downloaded in accordance with the present invention.

FIG. 10 depicts the same Application presenting multiple User Experiences dynamically in accordance with the present invention.

FIG. 11A illustrates the multiple Dynamic Layers stored on the Client Device in accordance with the present invention.

FIG. 11B depicts the multiple Dynamic Layers being downloaded from the Application Server in accordance with the present invention.

FIG. 11C illustrates only the updated Page Surface of the multiple Dynamic Layers being downloaded from the Application Server in accordance with the present invention.

FIG. 12A depicts a Client Device can load a given Application User Experience automatically in accordance with the present invention.

FIG. 12B shows the Client device selecting the User Experience within the Device in accordance with the present invention.

FIG. 12C depicts a Client Device can download a given Application User Experience automatically from the Application Server in accordance with the present invention.

FIG. 13 shows multiple Applications running on the same Native Layer in accordance with the present invention.

FIG. 14A illustrates one Native layer being downloaded from the Application Store and multiple Dynamic layers downloaded from the Application Server in accordance with the present invention.

FIG. 14B depicts several Applications stored on the Client Device in accordance with the present invention.

FIG. 14C illustrates several Applications stored on the Application Server and downloaded as needed in accordance with the present invention.

FIG. 14D depicts a Client Device downloading an Application automatically stored on the Application Server and in accordance with the present invention.

FIG. 15 illustrates an Umbrella Application which allows the user to select which Application is downloaded in accordance with the present invention.

FIG. 16A depicts Dynamic Layers running on top of each other in the Client Device in accordance with the present invention.

FIG. 16B shows Dynamic Layers running in parallel with each other in the Client Device in accordance with the present invention.

### DETAILED DESCRIPTION OF THE INVENTION

The System Solution offers the ownership, control and beneficial use of this inventive idea. The System solution offers the beneficial use to the Business Entity by providing Applications for the Business Entity. The Applications provided by the System Solution comprise a plurality of Application Components, and include Native Application Clients that run on Mobile, Non-Mobile, and Cloud Client Devices. These Native Application Clients can be modified by the Business Entity using Dashboards and can be downloaded to the Client Devices without the Business Entity having to submit the modified Native Application Client to the corresponding Application Store. The System Solution is the owner of all Application Components automatically generated by the System Solution. The System Solution creates and hosts Applications for different Business Entities (each Business Entity is a System Solution customer). The System Solution provides a complete environment for the creation, hosting, updating, and management of the Application. The Application Servers generated by the System Solution for all Business Entities are hosted in a multi-tenant environment in the Cloud, but each Business Entity “feels” like it is provided a dedicated Application Server. The System Solution architecture also applies with minor changes to a scenario where the System Solution Application Server run on dedicated servers owned by the Business Entity, rather than in the Cloud. In this scenario, the System Solution has access to control and offer beneficial use for those servers that are coupled to the Cloud.

Business Entities deploy their Applications to reach Consumers (i.e., the customers of that Business Entity served by System Solution). The Consumers are the primary End Users of the Application Clients generated by the System Solution. The Business Entities are the End Users of the Dashboards and the Application Server that the System Solution provides to each Business Entity for managing the corresponding Application.

Mobile Client Devices (cellular phones, smartphones, wearable devices, and tablets) and Non-Mobile Client Devices (laptops, desktops, and Internet-enabled TV sets) are coupled to the internet by wired (a physical interconnect), wirelessly (waves through space), or both wired/wireless networks. The wireless connectivity can be cellular (3G, 4G, etc.), Wi-Fi, Bluetooth, WiMax, etc. The network interconnecting these components is called the Communication network. The Client Device 1-2 has the Application Client which is the actual application software running on device. The term “Mobile” when used alone or in a larger phrase “Mobile Client Devices” can also imply the terms Mobile, Non-Mobile or in the Cloud. The term Mobile Client at times will be referred to as the Client Device. The term Application highlights the fact that the application built by the System Solution comprises a plurality of Application Components, and includes a portion of the Application that runs on the Client Device (the Application Client) and a portion of the application that runs on a server (the Application Server). The term “Application Client” refers to the portion of the application running on the Client Device. The term “Application Client” encompasses the Application Client running on a mobile Client Device, a non-mobile Client Device or even in the Cloud. The Cloud can run a portion of the Application Client in the server while the remaining portion of the Application Client can run on the Client Device, simultaneously. The term “Application Client” is used to refer to both Native and Non-Native Application Client. The term “Mobile Application Client” will be used for both Native and Non-Native Application Clients running on a mobile Client Device, but it also applies to Client Devices that are non-mobile or in the Cloud. The Application Client can be a part of the software running on the mobile or non-mobile Client Device or can be partially in the Cloud. In all cases, the Client Devices provide the End User with at least one mode of input and at least one mode of output through which the End User navigates and interacts with the Application Client.

Each Application includes a family of Application Clients. Each Application Client corresponds to a certain Client Device. The family of Application Clients includes a set of Native Mobile Application Clients, one per mobile platform. The family of Application Clients also includes a set of Native Non-Mobile Application Clients, one per non-mobile platform. The family of Application Clients also includes Non-Native Mobile and Non-Mobile Application Clients, and Application Clients residing in the Cloud. Some examples of the mobile platforms include the iPhone™, iPad™, Android™ phones, or tablets while the non-mobile platforms include the Apple Mac Operating System and the Microsoft Windows Operating System. For convenience, we use the term Mobile Application Client (or more succinctly Mobile Client) to refer to any Mobile Client in the family of Mobile Clients corresponding to an Application generated by the System Solution.

FIG. 5 depicts a Two-Layer Native Application Client 5-1 which is a Native Application Client that consists of two layers: a Dynamic Layer 5-3 and a Native Layer 5-2. The Native Layer 5-2 runs directly on the Operating System 2-13 of the Client Device 1-2 by using the system libraries 3-5 that are part of the Operating System 2-13. The Operating system runs on the hardware 2-16. The Dynamic Layer 5-3 does not run directly on the Operating System 2-13, but instead runs on the Native Layer 5-2 by making use of software libraries and functional blocks provided in the Native Layer 5-2. The Native Layer 5-2 and the Dynamic Layer 5-3 together implement the functionality and User Experience offered by the Two-Layer Native Application Client 5-1. The Native Layer 5-2 is an executable that depends on the Client Device 1-2 and needs to be downloaded and installed on the Client Device 1-2 using an installation manager external to the Two-Layer Native Application Client 5-1. The Native Layer 5-2 needs to be downloaded from the Application Store. The Dynamic Layer 5-3 does not need to be downloaded from the Application Store, but can be downloaded directly from an Application Server that is part of the System Solution. We use the term “Dynamic Native Application Client” as synonymous of the term “Two-Layer Native Application Client”. The Two-Layer Native Application Client is described in detail in U.S. patent application Ser. No. 13/______ titled “Dynamic User Interface Delivery System” filed on Mar. 15, 2013, which is incorporated in reference in its entirety. What is relevant in this application is that the inventive ideas contained in this application apply to the Two-Layer Native Application Client.

FIG. 6A illustrates the process of downloading the Two-Layer Native Application Client 5-1 to a Client Device 1-2 for the first time. The Two-Layer Native Application Client has a Dynamic Layer 5-3 and a Native layer 5-2. This process is similar to the process of downloading a Native Application Client 3-1 to the Client Device depicted in FIG. 4A. A Business Entity 4-1 creates a new application which comprises a Two-Layer Native Application Client 5-1. The new Two-Layer Native Application Client 5-1 is submitted 4-3 to the Application Store 1-10 for an approval process 4-4. Once the new Two-Layer Native Application Client is accepted 4-5, information is passed to the Application Store 1-10 to make the new Two-Layer Native Application Client available for download into a Client Device 1-2. A Client Device 1-2 which desires the Two-Layer Native Application Client 5-1 downloads the Two-Layer Native Application Client from the corresponding Application Store 1-10. Once the Two-Layer Native Application Client is downloaded to the Client Device, it is installed 6-1 on the Client Device so it can run on the Operating System 2-13 of the Client Device. The Operating system runs on the hardware 2-16. The Two-Layer Native Mobile Application Client 5-1 executable depends on the Operating System (OS) as an iPhone would require a different executable than an Android™ phone. If the Business Entity modifies the Native Layer 5-2, it needs to submit the new version of the Native Layer 5-2 to the Application Store for re-approval in order to make it available for download to the Client Device. In order to install the updated version of the Native Layer on the Client Device, the existing version of the Native Layer, if running on the Client Device 1-2, must be stopped and deleted from the memory of the Client Device 1-2 in order for the new version of the Native Layer to be installed on the Client Device. The Native Layer cannot be updated “on the fly” while the Two-Layer Native Application Client 5-1 is running on the Client Device 1-2.

FIG. 6B illustrates the process of downloading an updated Dynamic Layer 6-3 to the Client Device 1-2. If the Business Entity 4-1 modifies the functionality of the Dynamic Layer 6-2 and creates an Updated Dynamic Layer 6-3, it can make it available for download directly from an Application Server that is pan of the System Solution or is owned by the Business Entity. The new functionality 6-2 of the Dynamic Layer 5-3 is made available for download to the Client Device by being stored in the Application Server 6-4 without having the Business Entity submit it for approval to the Application Store 1-10. The updated Dynamic Layer 6-3 can be downloaded and installed 6-5 in the Client Device 1-2 while the Two-Layer Native Application Client 5-1 is running on the Client Device. The update of the existing Dynamic Layer can be achieved using an update manager 6-7 that is internal in the Native Layer 5-2 of the Two-Layer Native Application Client 5-1. Once the Updated Dynamic Layer 6-6 is downloaded and installed 6-5 on the Client Device 1-2, the new application client functionality and new User Experience 6-8 is provided to the end user.

FIG. 7A depicts a method and apparatus to automatically generate an Application consisting of several Application Components. A Business Entity 4-1 defines a Service Representation 7-1 and Business Entity Data 7-2. An Automatic Data Model Generator 7-3 takes the Service Representation 9-1 and the Business Entity Data 9-2 as inputs and automatically generates a Data Model 7-4, and from the Data Model 7-4 it generates a Common Data Model 7-5, a Server Data Model 7-6 and a Client Data Model 7-7. Using the generated Common Data Model 7-5, Server Data Model 7-6, and Client Data Model 7-7, an Automatic Application Generator 7-8 automatically generates all the Application Components. The generated Application Components include an Application Server 7-9, a set of Native Two-Layer Mobile Application Clients 7-10, a set of Native Two-Layer Non-Mobile Application Clients 7-11, a set of Non-Native Application Clients 7-12, Client Server Protocols 7-13, Dashboards 7-14, and Other Application Components 7-15. The set of Two-Layer Native Mobile Application Clients 7-10 comprises a Two-Layer Native Application Client executable for each mobile Client Device that the Native Mobile Application Client is desired to run on. The set of Two-Layer Native Non-Mobile Application Clients 7-11 comprises a Two-Layer Native Non-Mobile Application Client executable for each non-mobile Client Device that the Native Non-Mobile Application Client is desired to run on. The method and apparatus described in FIG. 7A is explained in detail in U.S. patent application Ser. No. 13/______ titled “Apparatus for Single Workflow for Multi-Platform Mobile Application Creation and Delivery” filed on Mar. 15, 2013, in U.S. patent application Ser. No. 13/______ titled “Method for Single Workflow for Multi-Platform Mobile Application Creation and Delivery” filed on Mar. 15, 2013, and in U.S. patent application Ser. No. 13/______ titled “Dynamic User Interface Delivery System” filed on Mar. 15, 2013, which are incorporated in reference in their entirety. What is relevant to this application is that the Two-Layer Native Application Client 5-1 can be automatically generated by the Business Entity 4-1 and the generated Dynamic Layer 5-3 of the generated Two-Layer Native Application Client 5-1 can be modified by the Business Entity 4-1 using automatically generated Dashboards 7-14 and made available for download to the Client Device 1-2 on an automatically generated Application Server 7-9 owned by the System Solution or by the Business Entity, without requiring to be re-submitted to the Application Store 1-10 for approval. The generated Client Server Protocols 7-13 can be used to download the modified Dynamic Layers to the Client Device 1-2.

FIG. 7B presents a Dynamic Layer Update flow which shows how the newly created Two-Layer Native Application Clients can be modified by the Business Entity 4-1 that creates the Business Entity Data 7-2 which is applied to the newly created Dashboards 7-14. The Dashboards feeds the dynamically Updated Data Model Generator 7-16 which is coupled to the Automatic Application Update Generator 7-17. The Automatic Application Update Generator generates the set of Dynamically Updated Native Mobile Application Clients 7-18 and the set of Dynamically Updated Native Non-Mobile Application Clients 7-19 are the updated Dynamic Layers of the corresponding Two-Layer Native Application Clients 5-1. Also shown are the Dynamically Updated Non-Native Mobile Application Clients 7-20, the Dynamically Updated Non-Native Non-Mobile Application Clients 7-21, and the Dynamically Updated Searchable Application Representation 7-22. Once this sequence has been established, the Business Entity can manipulate the business data applied to the Dashboards 7-14 and can continuously and automatically update the various Application Clients that this particular system generates.

FIG. 8A illustrates the structure of an Application Client 9-1, including a Two-Layer Native Application Client. The Application Client 8-1 comprises a plurality of Pages which comprises Page 1 8-3 to Page N 8-5. The Pages 8-3 to 8-5 are presented to the end user via an Application Client User Interface 8-2.

FIG. 8B depicts a Page 8-6 in the Two-Layer Native Application Client 5-1 which consists of a Page Surface 8-7 and a Page Foundation 8-8. The Page Surface can be changed dynamically and can be changed via Dashboards 8-10. The Page Foundation cannot be changed without submitting the updated Application Client to Application Store 8-11. The Page Surface 8-7 is part of the Dynamic Layer 5-3. The Page Foundation 8-8 is part of the Native Layer 5-2 and includes the Native Logic 8-9. The Dynamic Layer 5-3 of the Two-Layer Native Application Client 5-1 consists of the Page Surfaces 8-7 of all the Pages 8-6 comprised in the Two-Layer Native Application Client 5-1. The Native Layer 5-2 of the Two-Layer Native Application Client 5-1 consists of the Page Foundations 88 of all the Pages 8-6 comprised in the Two-Layer Native Application Client 5-1. Page Surfaces 8-7 and Page Foundations 8-8 are explained in detail in U.S. patent application Ser. No. 13/______ titled “Dynamic User Interface Delivery System” filed on Mar. 15, 2013, which is incorporated in reference in its entirety.

FIG. 9A shows an update process with which the Update Manager 6-6 contained in the Native Layer 5-2 of the Two-Layer Native Application Client 5-1 queries the Application Server 7-9 while the Two-Layer Native Application Client 5-1 is running on the Client Device 1-2 to check if a newer version of the Dynamic Layer that is currently running on the Client Device 1-2 is available in the Application Server 7-9. For this purpose, the Update Manager 6-6 uses a Dynamic Update Protocol 9-3, which is part of the generated Client Server Protocols 7-13. When a newer version of the Dynamic Layer becomes available in the Application Server 7-9, it is downloaded to the Client Device as an Updated Dynamic Layer of Native Application Client 9-1 using the Updated Dynamic Layer Download 9-2.

FIG. 9B shows an optimized alternative to the process described in FIG. 9A, in which, when the Update Manager 6-6 contained in the Native Layer 5-2 of the Two-Layer Native Application Client 5-1 queries the Application Server 7-9 to check whether a newer version of the Dynamic Layer is currently running on the Client Device 1-2. It also provides a List of the Desired Page Surfaces 9-8 that are needed to be displayed to the end user. When a newer version of the Dynamic Layer becomes available, only the Page Surfaces included in the List of Desired Page Surfaces 9-8 are downloaded using the Updated Desired Surface(s) Download 9-5 and places the Updated version into the Updated Dynamic layer of Native Application Client 9-1. The Dynamic Update Protocol 9-3 is coupled to the Application Server 7-9 containing Non-Updated Page Surfaces 9-7 and Updated Page Surfaces 9-6. The update process is described in detail in U.S. patent application Ser. No. 13/______ titled “Dynamic User Interface Delivery System” filed on Mar. 15, 2013, which is incorporated in reference in its entirety.

FIG. 10 illustrates a Two-Layer Native Application Client 1 10-1 which offers to the end user a plurality of Application 1 User Experiences comprising Application 1 User Experience 1 10-11 to Application 1 User Experience N 10-13. All of the Two-Layer Native Application Client 1 10-1 consists of a single Native Layer 1 10-7, which includes a Download Manager 10-10. The plurality of Application 1 Dynamic Layers comprising Application 1 Dynamic Layer 1 10-4 to Application 1 Dynamic Layer N 10-6 are distributed among the Two-Layer Native Application Client 1 10-1. Depending on which Application 1 Dynamic Layer is nm on the Native Layer 1 10-7, the Two-Layer Native Application Client 1 10-1 offers a different Application 1 User Experience to the end user. For example, when Application 1 Dynamic Layer 1 10-4 is run on Native Layer 1 10-7, the Two-Layer Native Application Client 1 10-1 offers Application 1 User Experience 1 10-11 to the end user.

The single Native Layer 1 10-7 needs to be downloaded once from the Application Store 1-10 and installed on the Client Device 1-2 so it can run on the Operating System 2-13 of the Client Device. The Native Layer 1 10-7 executable depends on the Operating System, as an iPhone would require a different executable than an Android™ phone. If the Business Entity modifies the Native Layer 1 10-7, it needs to submit the new version of the Native Layer 1 10-7 to the Application Store for re-approval in order to make it available for download to the Client Device. In order to install the updated version of the Native Layer 1 on the Client Device, the existing version of the Native Layer 1, if running on the Client Device 1-2, must be stopped and deleted from the memory of the Client Device 1-2 in order for the new version of the Native Layer 1 to be installed on the Client Device. The Native Layer cannot be updated “on the fly” while the Two-Layer Native Application Client 1 10-1 is running on the Client Device 1-2.

The plurality of Application 1 Dynamic Layers 10-4 to 10-6 can be downloaded to the Client Device directly from an application server 7-9 that is part of the system solution or is owned by the Business Entity. The Business Entity can modify the Application 1 Dynamic Layers in the plurality of Application 1 Dynamic Layers using the generated Dashboards 7-14 and make them available for download without having to submit the updated Application 1 Dynamic Layers to the Application Store for approval. The Business Entity can also add additional Application 1 Dynamic Layers to the plurality of Application 1 Dynamic Layers using the generated Dashboards 7-14 and make them available for download without having to submit the added Application 1 Dynamic Layers to the Application Store for approval.

The different Dynamic Layers can be loaded in the Two-Layer Native Application Client 1 10-1 while the Native Layer 1 10-7 is running on the Client Device 1-2. A first Application 1 Dynamic Layer 1 10-4 running on the Native Layer 1 10-7 can be substituted with a second Application 1 Dynamic Layer 2 10-5 without stopping the Two-Layer Native Application Client 1 10-1. Thus, by substituting Application 1 Dynamic Layers dynamically, the Two-Layer Native Application Client 1 10-1 can change the Application 1 User Experience that it offers to the user “on the fly.” The Business Entity 4-1 can change a certain Application 1 User Experience “on the fly,” by changing the corresponding Application 1 Dynamic Layer using the Dashboards 7-14. The Business Entity 4-1 can add new Application 1 User Experiences that the Two-Layer Native Application Client 1 10-1 can offer to the end user by creating new Application 1 Dynamic Layers using the Dashboards 7-14.

FIG. 11A shows a Two-Layer Native Application Client 1 10-1 that offers a plurality of Application 1 User Experiences to Client device 1-2 of the end user, where the plurality of all the available Application 1 Dynamic Layers 1 10-4, Application 1 Dynamic Layer 2 10-5, and Application 1 Dynamic Layer N 10-6 are stored on the Client Device. Depending on which Application 1 Dynamic Layer is running in the Two-Layer Native Application Client 1 10-1, the Two-Layer Native Application Client 1 offers a corresponding Application 1 User Experience 1 to the end user.

FIG. 11B shows a Two-Layer Native Application Client 1 10-1 in a Client device 1-2. An Application Server 7-9 stores the plurality of available Application 1 Dynamic Layers. The Download Manager 10-10 contained in the Native Layer 1 10-7 of the Two-Layer Native Application Client 1 10-1 queries the Application Server 7-9 while the Two-Layer Native Application Client 1 10-1 is running on the Client Device 1-2 to select one of the available Application 1 Dynamic Layers corresponding to a desired Application 1 User Experience. For this purpose, the Update Manager 10-10 uses a Dynamic Download Protocol 11-2, which is part of the generated Client Server Protocols 7-13. The desired Application 1 Dynamic Layer in the plurality of available Application 1 Dynamic Layers is downloaded to the Client Device using the Desired Application 1 User Experience i Download 11-3 and the Application 1 Dynamic Layer i 11-4 is run on the Client Device 1-2 so that the Two-Layer Native Application Client 1 10-1 offers the desired Application 1 User Experience i 1-5 to the end user. The desired Application 1 Dynamic Layer 1 10-4, Layer 2 10-5, and Layer N 10-6 can be downloaded to the Client Device 1-2 only when it is needed to be displayed to the end user.

FIG. 11C shows an optimized alternative to the process described in FIG. 11B. In this alternative process, when the Download Manager 10-10 contained in the Native Layer 1 10-7 of the Two-Layer Native Application Client 1 10-1 queries via the Dynamic Download Protocol 11-2 the Application Server 7-9 to select one of the available Application 1 Dynamic Layer 1 Page Surface 11-7, Application 1 Dynamic Layer 2 Page Surface 11-6, and Application 1 Dynamic Layer N Page Surface 11-5 corresponding to a desired Application 1 User Experience, it also provides a List of the Desired Page Surfaces 11-9 in the desired Application 1 Dynamic Layer that are needed to be displayed to the end user. Only the Page Surfaces included in the List of Desired Page Surfaces 11-9 are downloaded using the Desired Page Surfaces for Application 1 User Experience i Download 11-8, and the Application 1 Dynamic Layer i 11-4 is run on the Client Device 1-2 so that the Two-Layer Native Application Client 1 10-1 offers the desired Application 1 User Experience i 11-5 to the end user. Using this optimized alternative, the bandwidth usage and communication between the Client Device 1-2 and the Application Server 7-9 is optimized, and the memory storage of the Client Device 1-2 is optimized, since the entire desired Application 1 Dynamic Layer does not need to be downloaded to the Two-Layer Native Application Client 1 10-1. Only the Page Surfaces that have changed and that are desired by the end user need to be downloaded to the Two-Layer Native Application Client 10-1. An even more optimized second alternative to this process downloads only the Elements, Sub-Elements, and Navigation Parameters that have been updated in the Desired Page Surfaces. The second alternative is an optimal download process of the Two-Layer Native Application Client 1 10-1.

FIG. 12A shows that the Two-Layer Native Application Client 1 10-1 can Select Desired Application 1 User Experience 12-2 based on a Condition, Event 12-1. An example of an Event occurring is the Client Device 1-2 changing from being attached to the cellular network to being attached to the WiFi network (and vice versa). An Application may offer a different User Experiences depending on whether the connectivity is cellular or WiFi. Another example is the Client Device switching to Airplane Mode. In this latter case, the new User Experience corresponding to Airplane Mode must be available on the Client Device before Airplane Mode is turned on (since once in Airplane Mode, there is no connectivity to download it from the Application Server). Time and Date are added as further examples of Conditions or Events. For example, a condition may be of the form IF (date)=February 14 THEN (select user experience Valentine's Day), or IF (lunch time on a Sunday) THEN (select user experience BRUNCH Application). The Two-Layer Native Application Client 1 10-1 can evaluate a certain condition and, based on the result, select a first Application 1 Dynamic Layer in the plurality of available Application 1 Dynamic Layers. In another example, the Two-Layer Native Application Client 1 10-1 can identify the occurrence of a certain event and associate the event with the selection of a second Application 1 Dynamic Layer in the plurality of available Application 1 Dynamic Layers. For example, the condition can be the current location of the Client Device. For example, the location can be based on GPS coordinate computed by the client device or other location-determination mechanisms, such as cell-tower or WiFi triangulation. When the Two-Layer Native Application Client 1 10-1 computes the current location of the Client Device, if the Client Device location is inside a store, the Two-Layer Native Application Client 1 10-1 selects a first Application 1 Dynamic Layer 1 10-4; if the Client Device location is not inside a store, the Two-Layer Native Application Client 1 10-1 selects a second Application 1 Dynamic Layer 2 10-5. The Application 1 Dynamic Layer N 10-6 can be used for a different event. In this way, the Two-Layer Native Application Client 1 offers the end user a User Experience that changes dynamically based on a condition.

FIG. 12B shows the selection process depicted in FIG. 12A when the plurality of Application 1 Dynamic Layers is stored in the Client Device 1-2. Once the Condition, Event 12-1 is evaluated, the Select Desired Application 1 User Experience 12-2 is performed and the desired Application 1 Dynamic Layer 1 10-4 or the desired Application 1 Dynamic Layer N 10-6 is loaded via the Selected User Experience load 12-4, replaces the Application Dynamic Layer i 11-4 and runs in the Two-Layer Native Application Client 1 10-1. This provides the Application 1 User Experience i 11-5.

FIG. 12C shows the selection process depicted in FIG. 12A when the plurality of Application 1 Dynamic Layers are stored in the Application Server 7-9. The Condition, Event 12-1 is evaluated and the Select Desired Application 1 User Experience 12-2 is performed. The selected desired Application 1 User Experience is communicated to the Download Manager 10-10 in the Native Layer 1 10-7 which uses the Dynamic Download Protocol 11-2 and the List of Desired Page Surfaces 11-9 including Application 1 Dynamic Layer 1 11-7, Application 1 Dynamic Layer 2 11-6, and Application 1 Dynamic Layer N 11-5 for the Desired Page Surfaces for Selected Application 1 User Experience Download 11-8. In this way, the desired Application 1 Dynamic Layer i 11-4 is loaded in the Two-Layer Native Application Client 1 10-1 and the desired Application 1 User Experience i 11-5 is offered to the end user. Using this process, the bandwidth usage and communication between the Client Device 1-2 and the Application Server 7-9 is optimized, and the memory storage of the Client Device 1-2 is optimized

FIG. 13 illustrates a plurality of Two-Layer Native Application Clients comprising Two-Layer Native Application Client 1 13-1 to Two-Layer Native Application Client N 13-3. Each Two-Layer Native Application Client in the plurality of Two-Layer Native Application Clients is part of a corresponding Application in a plurality of Applications comprising Application 1 13-8 to Application N 13-10. All the Two-Layer Native Application Clients in the plurality of Two-Layer Native Application Clients comprise a Common Native Layer 13-4 and a common Download Manager 10-10. A first Two-Layer Native Application Client 1 13-1 corresponds to Application 1 13-8 and comprises Application 1 Dynamic Layer 13-5 and Common Native Layer 13-4. A second Two-Layer Native Application Client 2 13-2 corresponds to Application 2 13-6 and comprises Application 2 Dynamic Layer 13-6 and Common Native Layer 13-4. Depending on which Application 1 Dynamic Layer 13-5 to Application N Dynamic Layer 13-7 is run on the Common Native Layer 1 13-4, a different Application in the plurality of Applications is run on the Client Device 1-2.

Each Application in the plurality of Applications is generated by a Business Entity in a plurality of Business Entities using a method and apparatus such as the one depicted in FIG. 7A. Each Application consists of a plurality of Application Components including a set of Two-Layer Native Application Clients. Each Two-Layer Native Application Client in the set of Two-Layer Native Application Clients corresponding to each Application uses the same Common Native Layer 13-4. Each Two-Layer Native Application Client in the set of Two-Layer Native Application Clients corresponding to a first Application in the plurality of Applications can be modified using corresponding generated Dashboards. The Application 1 Dynamic Layer of a first Two-Layer Native Application Client 1 corresponding to a first Application 1 can be modified using a first generated Dashboards and made available for download to the Client Devices using a first generated Application Server and a first generated Client Server Protocols can be used to download the modified Application 1 Dynamic Layer to the Client Device 1-2.

FIG. 14A shows that the single Common Native Layer 13-4 needs to be downloaded once from the Application Store 1-10 and installed on the Client Device 1-2 so it can run on the Operating System 2-13 of the Client Device. The Common Native Layer 13-4 executable depends on the Operating System, as an iPhone™ would require a different executable than an Android™ phone. If a Business Entity in the plurality of Business Entities modifies the Common Native Layer 13-4, it needs to submit the new version of the Common Native Layer 13-4 to the Application Store for re-approval in order to make it available for download to the Client Device. In order to install the updated version of the Common Native Layer on the Client Device, the existing version of the Common Native Layer, if running on the Client Device 1-2, must be stopped and deleted from the memory of the Client Device 1-2 in order for the new version of the Native Layer 1 to be installed on the Client Device. The Common Native Layer 13-4 cannot be updated “on the fly” while a Two-Layer Native Application Client in the plurality of Two-Layer Native Application Clients comprising Two-Layer Native Application Client 1 13-1 to Two-Layer Native Application Client N 13-3 is running on the Client Device 1-2.

The plurality of Application Dynamic Layers 13-5 to 13-7 corresponding to the plurality of Applications 13-8 to 13-10 can be downloaded to the Client Device directly from a plurality of application servers that are part of the system solution or is owned by the Business Entity. The Business Entity can modify the Application Dynamic Layer of the Application generated by the business solution using the generated Dashboards and make them available for download without having to submit the updated Application Dynamic Layers to the Application Store for approval.

The different Application Dynamic Layers in the plurality of Application Dynamic Layers comprising Application 1 Dynamic Layer 13-5 to Application N Dynamic Layer 13-7 can be loaded in the corresponding Two-Layer Native Application Client while the Common Native Layer 13-4 is running on the Client Device 1-2. Using these inventive ideas, the plurality of Applications comprising Application 1 13-8 to Application N 13-10 can be downloaded 14-1 from the Application server to the Client Device by downloading a single Common Native Layer 13-4 from the Application Store 1-10 once and downloading all the corresponding Application Dynamic Layers from a plurality of application servers owned by the System Solution or by a plurality of Business Entities. A first Application 1 13-8 using the Common Native Layer 13-4 can be substituted with a second Application 2 13-9 without stopping the first Application 1 13-8. The second Application 2 13-9 can be downloaded and installed on the Client Device without stopping the first Application 1 13-8. The Business Entity can change a certain Application 1 13-8 e “on the fly,” by changing the corresponding Application 1 Dynamic Layer 13-5 using the generated Dashboards.

FIG. 14B shows a plurality of Applications sharing a Common Native Layer 13-4 where the plurality of Application Dynamic Layers 13-5 to 13-7 for the plurality of Applications is stored on the Client Device 1-2. Depending on which Application Dynamic Layer in the plurality of Application Dynamic Layers 13-5 to 13-7 is running on the Common Native Layer, a different Application, in this example Application 1 13-8, in the plurality of Applications is running on the Client Device.

FIG. 14C shows a plurality of Applications sharing a Common Native Layer 13-4 where the plurality of Application Dynamic Layers 13-5 to 13-7 for the plurality of Applications is stored on an Application Server 7-9. The Download Manager 10-10 contained in the Common Native Layer 13-4 queries the Application Server 7-9 while the Common Native Application Client 13-4 is running on the Client Device 1-2 to select one of the available Applications in the plurality of Applications and download the corresponding Application Dynamic Layer from the Application Server 7-9. For this purpose, the Update Manager 10-10 uses a Dynamic Download Protocol 11-2, which is part of the generated Client Server Protocols. The desired Application 1 Dynamic Layer in the plurality of available Application 1 Dynamic Layers is downloaded to the Client Device using the Desired Application Dynamic Layer Download 14-3. The desired Application Dynamic Layer 1 13-5 can be downloaded to the to the Native Application Client 1 13-1 only when the Application is needed to be displayed to the end user. This provides Application 1 13-8 to the end user on Client Device 1-2

FIG. 14D shows that the Common Native Layer 13-4 can select to download a certain Application in the plurality of Applications on an Application server 7-9 based on a Condition, Event 12-1. The Condition, Event 12-1 couples to the Select Application 14-4 and informs the Download manager 10-10 to enable the Dynamic Download Protocol 11-2. For example, the Common Native Layer 13-4 can evaluate a certain condition and, based on the result, select a first Application 1 13-8 in the plurality of available Applications using the Desired application Dynamic Layer Download 14-3. In another example, the Common Native Layer 13-4 can identify the occurrence of a certain event and associate the event with the selection of a second Application 2 13-6 in the plurality of available Applications. For example, the condition can be the current location of the Client Device. When the Common Native Layer 13-4 computes the current location of the Client Device, if the Client Device location is inside a first Store A owned by a first Business Entity, the Common Native Layer 13-4 selects and downloads a first Application 1 13-5 generated by the first Business Entity. If the Client Device location is inside a second Store B owned by a second Business Entity, the Common Native Layer 13-4 selects and downloads a second Application N 13-7 generated by the second Business Entity. In this way, the Client Device 1-2 can automatically download and run Applications based on a condition or on the occurrence of an event.

FIG. 15 shows an Umbrella Application 15-7 of a Umbrella Native Application Client 1 15-1 using the same Common Native Layer 13-4 of the plurality of Applications comprising Application 1 13-5 to Application N 13-7. The Umbrella Application 15-7 comprises the Common Native Layer 13-4 and an Umbrella Application Dynamic Layer 15-2. Using the Umbrella Application 15-7 the User Selects Which Application to Run 15-3 in the plurality of Applications 13-5 to 13-7 and the corresponding Application Dynamic Layer in the plurality of Application Dynamic Layers comprising Application 1 Dynamic Layer 13-5 to Application N Dynamic Layer 13-7 is selected. The Selected Application is Loaded 15-4 by downloading the Selected Application Dynamic Layer 15-5 to the Client Device and the Selected Native Application Client 15-6 is run on the Client Device providing the selected Application 15-8 to the end user.

FIG. 16A shows two Applications in the plurality of Applications comprising Application 1 13-8 and Application 2 13-9 on a Client device 1-2. The first Application 1 13-8 comprises the Two-Layer Native Application Client 1 13-1 which consists of the Common Native Layer 13-4 and Application 1 Dynamic Layer 13-5. The second Application 2 13-9 comprises the Two-Layer Native Application Client 2 13-2 which consists of the Common Native Layer 13-4, Application 1 Dynamic Layer 13-5, and Application 2 Dynamic Layer 13-6. Application 1 Dynamic Layer 13-5 runs on the Common Native Layer 13-4. Application 2 Dynamic Layer 13-6 runs on Application 1 Dynamic Layer 13-5. Using these inventive ideas, Application 2 13-9 uses functionality provided by Application 1 13-8 as part of its functionality provided to the end user. The end user can access the functionality provided by Application 1 13-8 using the functionality provided by Application 2 13-9. Both Application 1 Dynamic Layer 13-5 and Application 2 Dynamic Layer 13-6 can be downloaded directly from an Application Server 7-9 owned by the System Solution or by the Business Entities while the Common Native Layer 13-4 is running.

FIG. 16B shows a plurality of Applications comprising Application 1 13-8 to Application N 13-10 and a corresponding plurality of Two-Layer Application Clients comprising Two-Layer Application Client 1 13-1 to Two-Layer Application Client N 13-3. All Two-Layer Native Application Clients in the plurality of Two-Layer Native Application Clients share a Common Native Layer 13-4. A first Two-Layer Native Application Client 1 13-1 consists of the Common Native Layer 13-4 represented by the doubled lined box 13-4 and a first Application 1 Dynamic Layer 13-5. A second Two-Layer Native Application Client 2 13-2 consists of the Common Native Layer 13-4 and a second Application 2 Dynamic Layer 13-6. An N^{th} Two-Layer Native Application Client N 13-3 consists of the Common Native Layer 13-4 and a N^{th} Application N Dynamic Layer 13-7. The first Application 1 Dynamic Layer 13-5 and the second Application 2 Dynamic Layer 2 13-6 run on the Common Native Layer 13-4 at the same time. The first Two-Layer Application Client 1 13-1 and the second Two-Layer Native Application Client 2 13-2 run on the Client Device at the same time. The corresponding Application 1 13-8 and Application 2 13-9 run on the Client Device at the same time. Using these inventive ideas, multi-tasking of Application 1 13-8 and Application 2 13-9 is provided to the end user. Multi-tasking of Application 1 13-8 and Application 2 13-9 is provided to the end user even on a Client Device that only allows a single Native Application Client to run at a given time and does not provide multi-tasking of Native Application Clients.

Finally, it is understood that the above descriptions are only illustrative of the principle of the current invention. Various alterations, improvements, and modifications will occur and are intended to be suggested hereby, and are within the spirit and scope of the invention. This invention can, however, be embodied in many different forms and should not be construed as limited to the embodiments set forth herein. Rather, these embodiments are provided so that the disclosure will be thorough and complete, and will fully convey the scope of the invention to those skilled in the arts. It is understood that the various embodiments of the invention, although different, are not mutually exclusive. In accordance with these principles, those skilled in the art can devise numerous modifications without departing from the spirit and scope of the invention. For example, in addition, a network and a portable system can exchange information wirelessly by using communication techniques such as Time Division Multiple Access (TDMA), Frequency Division Multiple Access (FDMA), Code Division Multiple Access (CDMA), Orthogonal Frequency Division Multiplexing (OFDM), Ultra Wide Band (UWB), Wi-Fi, WiGig, Bluetooth, etc. The network can comprise the phone network, IP (Internet protocol) network, Local Area Network (LAN), ad hoc networks, local routers and even other portable systems. In addition, the term “Mobile Client Device” can be used for mobile devices such as cellphone, tablets, etc. “Non-Mobile Client Device” can be used for non-mobile devices such as desktops. “Cloud Client Device” can be used for the device formed in the Cloud. At other instants the term “Client Device” can imply either the “Mobile Client Device,” “Non-Mobile Client Device” or “Cloud Client Device.”

What is claimed is:

1. A System Apparatus comprising:
a Client Device with a Two-Layer Native Application Client, a first Operating System, a first hardware, and a first screen;
said Two-Layer Native Application Client with a Native Layer and a first Dynamic Layer; and
a plurality of first Dynamic Layers stored on said Client Device to offer a Business Entity a way to generate a plurality of User Experiences for said Client Device.

2. The System Apparatus of claim 1, further comprising:
a plurality of conditions associated with each of said plurality of first Dynamic Layers; and
said plurality of conditions are also events based on Client Device location, date, time, network connectivity, and Client Device state.

3. The System Apparatus of claim 1, wherein
said Two-layer Native Application Client was downloaded from an Application store.

4. The System Apparatus of claim 1, further comprising:
a System Solution to automatically generate said Two-Layer Native Application Client that offers a Business Entity a way to generate said plurality of User Experiences.

5. The System Apparatus of claim 1, further comprising:
a new User Experience from said plurality of User Experiences stored on said Client Device is automatically generated by said Two-Layer Native Application Client based on a new condition from a plurality of conditions.

6. The System Apparatus of claim 1, further comprising:
a Download manager located in said Native Layer of said Client Device;
a plurality of second Dynamic Layers stored on an Application Server to offer said Business Entity a way to generate a second plurality of User Experiences for said Client device;
said Two-Layer Native Application Client automatically downloads at least one new Dynamic Layer from said Application Server to generate at least one new User Experience from said second plurality of User Experiences for said Client Device.

7. The System Apparatus of claim 1, further comprising:
a Download manager located in said Native Layer of said Client Device;
a plurality of second Dynamic Layers stored on an Application Server to offer said Business Entity a way to generate a second plurality of User Experiences for said Client device;
said Two-Layer Native Application Client automatically evaluates at least one new condition from a plurality of conditions and based on the evaluated condition downloads at least one new Dynamic Layer from said Application Server to generate at least one new User Experience from said second plurality of User Experiences for said Client Device.

8. The System Apparatus of claim 7, further comprising:
updated components of Page Surfaces of said at least one new Dynamic Layer are only downloaded to optimize a bandwidth utilization of a communication link between said Client Device and said Application Server.

9. A method of downloading multiple Dynamic Layers comprising the steps of:
generating a plurality of Application Clients automatically using a System Solution with at least one first server and with at least one Computing device;
coupling said plurality of Application Clients to a Client Device where each Application Client in said plurality of Application Clients is a Two-layer native Application Client comprising a Native Layer and a Dynamic Layer;
allowing said Native Layer to be a Common Native Layer; and
downloading automatically from an Application Server multiple Dynamic Layers corresponding to different Application Clients in said plurality of Application Clients to said Client Device.

10. The method of claim 9, wherein
said coupling of said entire plurality of Application Clients is through the coupling of a single Application Client through an Application Store.

11. The method of claim 9, further comprising the steps of:
allowing a User of said Client Device to select a desired Application; and
downloading said one desired Dynamic layer of said multiple Dynamic Layers to said Client Device.

12. The method of claim 9, further comprising the steps of:
using a Download Manager in said Common Native Layer to select said multiple Dynamic layers in said Application Server.

13. The method of claim 9, further comprising the steps of:
selecting a desired Application based on a plurality of condition at said Client Device; and
using a Download Manager in said Common Native Layer to select and download one of said multiple Dynamic layers in said Application Server.

14. The method of claim 13, wherein
said plurality of conditions are also events based on Client Device location, date, time, network connectivity, and Client Device state.

15. The method of claim 9, further comprising the steps of:
downloading only updated components of Page Surfaces of said multiple Dynamic Layers; and
optimizing a bandwidth utilization of a communication link between said Client Device and said Application Server.

16. A method of running multiple Dynamic Layers at the same time comprising the steps of:
generating a plurality of Application Clients automatically using a System Solution with at least one first server and with at least one Computing device;
coupling said plurality of Application Clients to a Client Device where each Application Client in said plurality of Application Clients is a Two-layer native Application Client comprising a Native Layer and a plurality of Dynamic Layers;
allowing said Native Layer to be a Common Native Layer;
downloading automatically from an Application Server at least two or more of a plurality of Dynamic Layers corresponding to different Applications to said Client Device; and
running said downloaded said at least two or more of said plurality of Dynamic Layers in a series configuration or a parallel configuration simultaneously.

17. The method of claim 16, comprising the steps of:
running a first of said at least two or more of said plurality of Dynamic Layers on a second of said at least two or more of said plurality of Dynamic Layers;
running said second of said at least two or more of said plurality of Dynamic Layers simultaneously on said Common Native Layer; and
forming said series configuration.

18. The method of claim 16, comprising the steps of:
running a first of said at least two or more of said plurality of Dynamic Layers on said Common Native Layer;
running at least one of remaining said at least two or more of said plurality of Dynamic Layers simultaneously on said Common Native Layer; and
forming said parallel configuration.

19. The method of claim 18, further comprising the steps of:
achieving multi-tasking between different Applications; and
allowing a Client Device which does not support said multi-tasking to support said multi-tasking.

20. The method of claim 16, wherein
a first portion of said plurality of Dynamic Layers can be stored in said Client Device and the remaining portion of said plurality of Dynamic Layers can be stored in an Application Server.
